(19) United States
(12) Patent Application Publication
(10) Pub. No.: US 2020/0396803 A1
(43) Pub. Date: Dec. 17, 2020

(54) SURFACE TYPE HEATING ELEMENT AND MANUFACTURING METHOD THEREOF

(71) Applicant: LG ELECTRONICS INC., Seoul (KR)

(72) Inventor: Changwoo JEONG, Seoul (KR)

(73) Assignee: LG ELECTRONICS INC., Seoul (KR)

(21) Appl. No.: 16/899,042

(22) Filed: Jun. 11, 2020

(30) Foreign Application Priority Data
Jun. 12, 2019 (KR) 10-2019-0069421

(51) Int. Cl. H05B 3/74; H05B 3/20; F24C 7/04

(52) U.S. Cl. CPC H05B 3/74; H05B 2203/017; F24C 7/046; H05B 3/20

(57) ABSTRACT

Discussed are a surface type heating element which generates heat using electricity and a method of manufacturing the surface type heating element. The surface type heating element includes: a substrate; a buffer layer disposed on the substrate, the buffer layer having a thermal expansion coefficient of about 50*10⁻⁷ to about 100)*10⁻⁷ m/° C.; and a surface type heating element layer disposed on the buffer layer and including a NiCr alloy, and thus it can be used even at a high operating temperature of about 450° C. or more, suppresses the elution of the material itself, and allows thermal stress caused by a difference in coefficient of thermal expansion between the surface type heating element layer and the substrate to be reduced while having high fracture toughness, a low coefficient of thermal expansion, and heat resistance.

### CROSS-REFERENCE TO RELATED APPLICATION

This application claims priority to and the benefit of Korean Patent Application No. 10-2019-0069421, filed in the Republic of Korea on Jun. 12, 2019, the entire contents of which is hereby expressly incorporated by reference into the present application.

### BACKGROUND OF THE INVENTION

### Field of the Invention

The present disclosure relates to a surface type heating element which generates heat using electricity in the field of heating devices such as electric ranges and a method of manufacturing the surface type heating element.

### Description of the Related Art

Cooktops used as household or commercial cooking appliances are cooking appliances that heat food contained in a container placed on the upper surface of the cooktop by heating the container.

Cooktops in the form of a gas stove which generate a flame using gas generate toxic gases and the like during the combustion process of the gas. Toxic gases not only directly cause adverse effects on the health of the cooker but also cause the pollution of indoor air. In addition, the cooktops in the form of a gas stove require a ventilation system for eliminating toxic gases or contaminated air, resulting in additional economic costs.

In recent years, in order to replace the cooktops in the form of a gas stove, cooktops in the form of an electric range including a surface type heating element which generate heat by applying an electric current have been frequently used.

As the surface type heating element, a metal heating element made by etching a metal thin plate containing iron, nickel, silver, or platinum or a non-metal heating element containing silicon carbide, zirconia, or carbon is currently being used.

The metal materials of the surface type heating element are vulnerable to heat when continuously exposed to high temperature, and the non-metal materials are not easily manufactured and tend to be broken. To solve the above problems, surface type heating elements manufactured by firing metals, metal oxides, ceramic materials, and or like at high temperature for a long time have been used in recent years.

The surface type heating elements for firing include, as a main component, metal components having a melting point relatively lower than that of oxides or ceramics. Most of the heating elements including metals having a low melting point have a relatively low operation temperature of about 400° C. due to the limitation on a melting point, and thus it is difficult to use the heating elements at a high cooking temperature. Furthermore, existing heating elements including metals having a low melting point can adversely affect the reliability of the product due to the elution of the metal component having a low melting point during use of a cooktop.

On the other hand, in order to manufacture a surface type heating element by firing materials having a high melting point, such as some metals, metal oxides, or ceramics, there is limitation on the material.

Specifically, in order to fire components having a high melting point, first, the substrate material has to be limited to a material having a high melting point to withstand a high-temperature firing process. The limitation on the substrate material acts as a hurdle in designing a cooktop product to which a surface type heating element is applied.

Meanwhile, surface type heating elements also have several issues in terms of a material. For example, noble metals such as silver (Ag) are oxidized due to exposure to high temperature when applied in the surface type heating element. In addition, when applied in the surface type heating element, ceramic materials are subjected to thermal fatigue or thermal shock by repeatedly heating and cooling the surface type heating element, causing a decrease in the lifetime of a cooktop.

In particular, among components having a high melting point, metal oxides or ceramic materials have low fracture toughness due to the inherent embrittlement of the materials themselves.

Meanwhile, some components among metals, metal oxides, and ceramics have a coefficient of thermal expansion (CTE) much higher than that of the substrate. The coefficient of thermal expansion of the surface type heating element is a major factor that directly determines thermal shock or thermal stress which is generated between the surface type heating element layer and the substrate. The difference in coefficient of thermal expansion between the surface type heating element layer and the substrate results from a decrease in adhesion between the surface type heating element layer and the substrate and thus acts as a direct cause of decreasing the lifetime of the final product cooktop. In particular, when the surface type heating element layer includes a metal component, and the substrate is glass and/or a ceramic, the difference in coefficient of thermal expansion between the surface type heating element layer and the substrate interacts with weak coupling between the dissimilar materials, causing a further decrease in the reliability and lifetime of the cooktop.

### SUMMARY OF THE INVENTION

The present disclosure is directed to providing a surface type heating element which can be used even at a high operating temperature of 450° C. or more as well as an operating temperature of an electric range cooktop and does not allow the elution of the material during use of an electric range.

The present disclosure is also directed to providing a surface type heating element which has high resistance to thermal shock and the like by having high fracture toughness and, furthermore, is subjected to decreased thermal shock by having a low coefficient of thermal expansion within the range from room temperature to the operating temperature at which the electric range can be used, resulting in improving reliability and lifetime.

Meanwhile, the present disclosure is also directed to providing a buffer layer which is disposed between a surface type heating element layer and a substrate and thus allows thermal shock or thermal stress caused by a difference in coefficient of thermal expansion between the surface type heating element layer and the substrate to be reduced. In particular, the present disclosure is also directed to providing a buffer layer which does not cause a undesired reaction with the surface type heating element layer and the substrate, is stable even at high temperature, and has a controlled component and composition ranges so that the buffer layer has a thermal expansion coefficient between the thermal expansion coefficient of the surface type heating element layer and the thermal expansion coefficient of the substrate or similar to the thermal expansion coefficient of the surface type heating element.

In addition, the present disclosure is directed to providing a surface type heating element which allows the material to be prevented from being oxidized by reducing an exposure time of the material to high temperature by shortening a process time in the manufacture thereof, and a manufacturing method thereof.

In particular, the present disclosure is directed to providing a method of manufacturing a surface type heating element, which allows the substrate to be prevented from being thermally deformed or destroyed by lowering a high sintering temperature and shortening a process time by integrating a process and designing a material.

The present disclosure is also directed to providing a method of manufacturing a surface type heating element, which allows a process time and energy to be reduced by excluding a high-temperature process in the manufacture of a surface type heating element and thus has no limitation on the material of the substrate.

The present disclosure is also directed to providing a method of manufacturing a surface type heating element, which does not require a reducing process atmosphere for preventing the material from being oxidized due to a high process temperature.

A surface type heating element according to an embodiment of the present disclosure includes: a substrate; a buffer layer disposed on the substrate and having a thermal expansion coefficient of (50 to 100)*10⁻⁷ m/° C.; and a surface type heating element layer disposed on the buffer layer and including a NiCr alloy, so that it can be used even at a high operating temperature of 450° C. or more, suppresses the elution of the material itself, and allows thermal stress caused by a difference in coefficient of thermal expansion between the surface type heating element layer and the substrate to be reduced while having high fracture toughness, a low coefficient of thermal expansion, and heat resistance.

For example, the surface type heating element provides that the substrate can be formed of any one of glass, a glass ceramic, Al₂O₃, AlN, polyimide, polyether ether ketone (PEEK), and a ceramic is provided.

For example, the surface type heating element provides that the buffer layer can have a thickness of 1 to 10 μm is provided.

For example, the surface type heating element provides that the buffer layer can have an electrical resistivity of 10⁴ to 10⁵ Ωcm is provided.pr

For example, the surface type heating element provides that the buffer layer can include a glass frit, and the glass frit can include SiO₂ at 60 to 70 wt %, B₂O₃ at 15 to 25 wt %, Al₂O₃ at 1 to 10 wt %, an alkali oxide at 10 wt % or less (excluding 0%), and BaO at 1 to 5 wt % is provided.

For example, the surface type heating element provides that the glass frit can have a softening point of 600 to 700° C. is provided.

For example, the surface type heating element provides that a Ni content of the NiCr alloy can range from 60 to 95 wt % is provided.

For example, the surface type heating element provides that the surface type heating element can have an electrical resistivity of 10⁻⁴ to 10⁻² Ωcm is provided.

A method of manufacturing a surface type heating element according to another embodiment of the present disclosure includes: providing a substrate; forming a buffer layer disposed on the substrate and having a thermal expansion coefficient of (50 to 100)*10⁻⁷ m/° C.; applying a surface type heating element layer including a NiCr alloy onto the buffer layer; drying the applied surface type heating element layer; and sintering the dried surface type heating element layer, so that it is capable of preventing the substrate from being thermally deformed or destroyed by lowering a high sintering temperature and shortening a process time and preventing the material from being oxidized by reducing an exposure time of the material to high temperature by shortening a process time.

For example, the method of manufacturing a surface type heating element, provides that the forming of the buffer layer can include: applying the buffer layer; drying the applied buffer layer; and sintering the dried buffer layer, and the dried buffer layer and the dried surface type heating element layer can be co-sintered, is provided.

For example, the method of manufacturing a surface type heating element, provides that the co-sintering can be performed at a sintering temperature of 750 to 950° C. for a sintering time of 0.1 to 2 hours, is provided.

Alternatively, according to the method of manufacturing a surface type heating element according to another embodiment of the present disclosure, the forming of the buffer layer can include: applying the buffer layer; drying the applied buffer layer; and sintering the dried buffer layer, and the sintering of the dried surface type heating element layer can be performed by photonic sintering, so that it is capable of reducing a process time and energy by excluding a high-temperature process in the manufacture of a surface type heating element, has no limitation on the material of the substrate, and does not require a reducing process atmosphere for preventing the material from being oxidized.

For example, the method of manufacturing a surface type heating element, provides that the substrate can be formed of any one of glass, a glass ceramic, Al₂O₃, AlN, polyimide, polyether ether ketone (PEEK), and a ceramic, is provided.

For example, the method of manufacturing a surface type heating element, provides that the buffer layer can have a thickness of 1 to 10 μm, is provided.

For example, the method of manufacturing a surface type heating element, provides that the buffer layer can have an electrical resistivity of 10⁴ to 10⁵ Ωcm, is provided.

For example, the method of manufacturing a surface type heating element, provides that the buffer layer can include a glass frit, and the glass frit can include SiO₂ at 60 to 70 wt %, B₂O₃ at 15 to 25 wt %, Al₂O₃ at 1 to 10 wt %, an alkali oxide at 10 wt % or less (excluding 0%), and BaO at 1 to 5 wt %, is provided.

For example, the method of manufacturing a surface type heating element, provides that the glass frit can have a softening point of 600 to 700° C., is provided.

For example, the method of manufacturing a surface type heating element, provides that a Ni content of the NiCr alloy can range from 60 to 95 wt %, is provided.

For example, the method of manufacturing a surface type heating element, provides that the surface type heating element layer can have an electrical resistivity of 10⁻⁴ to 10⁻² Ωcm, is provided.

### BRIEF DESCRIPTION OF THE DRAWINGS

The above and other objects, features and advantages of the present disclosure will become more apparent to those of ordinary skill in the art by describing exemplary embodiments thereof in detail with reference to the accompanying drawings, in which:

FIG. 1 is a plan view of a surface type heating device according to an embodiment of the present disclosure as viewed from above a substrate;

FIG. 2 is an enlarged cross-sectional view illustrating one example of a portion taken along A-A′ of the surface type heating device of FIG. 1:

FIG. 3 is an enlarged cross-sectional view illustrating another example of a portion taken along A-A′ of the surface type heating device of FIG. 1;

FIG. 4 shows an example in which a heater module is destroyed due to a short circuit occurring in the heating element of the surface type heating element layer due to a decrease in resistivity of a substrate during high-power operation;

FIG. 5 is a scanning electron microscope (SEM) image of a surface type heating element layer formed on a buffer layer formed of glass frit with a composition of Example 1; and

FIG. 6 is an SEM image of a surface type heating element layer formed on a buffer layer formed of glass frit with a composition of Comparative Example 1.

### DETAILED DESCRIPTION OF THE EMBODIMENTS

The above objects, features and advantages of the present disclosure will be described in detail with reference to the accompanying drawings, and therefore, the technical idea of the present disclosure should be easily implemented by those of ordinary skill in the art. In the following description of the present disclosure, when a detailed description on the related art is determined to unnecessarily obscure the subject matter of the present disclosure, the detailed description will be omitted. Hereinafter, exemplary embodiments of the present disclosure will be described in detail with reference to the accompanying drawings. In the drawings, the same reference numerals are used to indicate the same or similar components.

Hereinafter, the disposition of any component disposed on an “upper portion (or lower portion)” of a component or disposed “on (or under)” a component can mean that not only the arbitrary component is disposed in contact with the upper surface (or lower surface) of the component but also another component can be interposed between the component and the arbitrary component disposed on (or under) the component.

In addition, it should be understood that when an element is described as being “connected” or “coupled” to another element, the element can be directly connected or coupled to another element, other elements can be “interposed” between the elements, or each element can be “connected” or “coupled” through other elements.

Hereinafter, a surface type heating element and a manufacturing method thereof according to some embodiments of the present disclosure will be described.

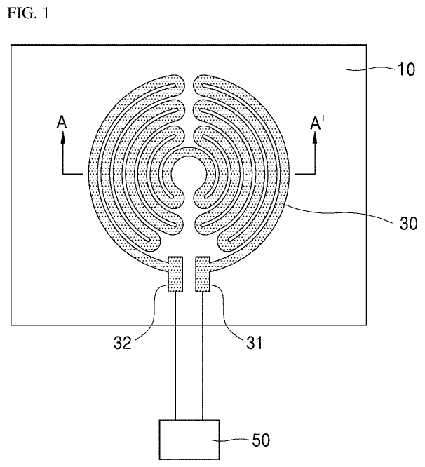

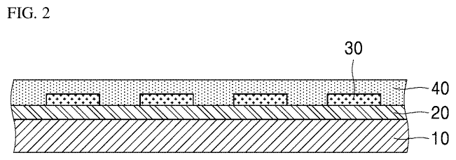

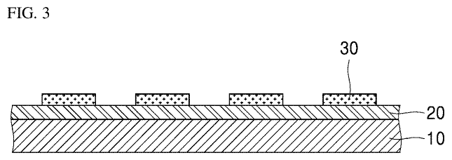

Referring to FIGS. 1 to 3, an electric range 1 according to an embodiment of the present disclosure includes a substrate 10 whose surface is made of an electrically insulating material, a buffer layer 20 disposed on the substrate 10, a surface type heating element layer 30 formed by sintering a predetermined powder containing an oxide powder and disposed on the buffer layer 20 disposed on the substrate 10, and a power supply unit 50 configured to supply electricity to the surface type heating element layer 30.

In this instance, the substrate 10 can be manufactured in various sizes and shapes according to the needs of a device using the electric range 1. As a non-limiting example, the substrate 10 of the present disclosure can be a plate-shaped member. In addition, the substrate 10 can have a different thickness for each position in the substrate as necessary. Furthermore, the substrate 10 can be bent as necessary.

In the present disclosure, the material forming the substrate 10 is not particularly limited as long as it is an insulating material. As a non-limiting example, the substrate in the present disclosure can be not only a ceramic substrate containing glass, a glass ceramic, alumina (Al₂O₃), aluminum nitride (AlN), or the like but also formed of a polymer material such as polyimide (PI) or polyether ether ketone (PEEK). However, the substrate can include any one of glass, a glass ceramic, and a ceramic. This is because these materials are basically able to ensure insulating properties and are advantageous in terms of anti-staining, an anti-fingerprint effect, and visual properties as compared to other materials. Particularly, a glass ceramic can be the most preferred because the glass ceramic can ensure impact resistance and low expandability in addition to the advantages of general amorphous glass, such as transparency and aesthetics, as compared with other ceramic materials.

The buffer layer 20 can be disposed on any one of both surfaces of the substrate 10, for example, the surface on which the surface type heating element layer 30 is formed. When the electric range of the embodiment of the present disclosure includes the buffer layer 20, the buffer layer 20 should be formed on an entirety or part of the substrate 10. In this instance, the part of the substrate means at least a portion of the substrate that the user can touch during operation of the electric range and/or a portion in which the surface type heating element layer and the substrate are in contact with each other.

The buffer layer 20 functions to suppress thermal shock or thermal stress generated due to a difference in coefficient of thermal expansion between the substrate and the surface type heating element layer during operation (heating) of a cooktop and to suppress peeling of the surface type heating element layer due to the thermal shock or thermal stress.

When the surface type heating element layer 30 is made of a ceramic-based material which is the same as or similar to that of the substrate, since the substrate and the surface type heating element layer are the same type of material, bonding strength at their interface is high and thermal expansion coefficients are similar to each other at the same time. However, the ceramic-based materials have a fundamental problem in which the ceramic-based materials are vulnerable even to less thermal stress or thermal shock due to having low fracture toughness.

On the other hand, a conventional surface type heating element layer including a metal-based material having excellent fracture toughness exhibits excellent fracture toughness but also has a large difference in coefficient of thermal expansion from a substrate and causes the elution of the active component at high temperature.

In particular, when the surface type heating element layer is formed of a material dissimilar to the substrate and including a metal material, the weak binding between the substrate and the surface type heating element layer is further weakened due to a difference in coefficient of thermal expansion between the substrate and the surface type heating element layer, eventually leading to peeling of the surface type heating element layer.

Characteristics according to the material of the surface type heating element layer 30 are more specifically summarized in Table 1 below. Particularly, the following Table 1 summarizes the mechanical and electrical properties of the NiCr alloy used to form the surface type heating element layer 30 of the embodiment of the present disclosure and materials for a surface type heating element which are currently being used or known.

TABLE 1
Mechanical/electrical properties of materials
for surface type heating element

| | Fracture | Coefficient of | |
|---|---|---|---|
| | toughness | thermal expansion | Resistivity |
| Components | (MPam^{1/2}) | (m/° C.) | (Ω cm) |
| Ag | 40~105 | 180*10⁻⁷ | 1.6*10⁻⁶ |
| Lanthanum Cobalt | 0.9~1.2 | 230*10⁻⁷ | 9.0*10⁻³ |
| Oxide | | | |
| Glass | 0.6~0.9 | 1*10⁻⁷ | — |
| MoSi₂ | 6.0 | 65~90*10⁻⁷ | 2.7*10⁻⁵ |
| SiC | 4.6 | 40*10⁻⁷ | 1.0*10⁻² |
| NiCr | 110 | 120*10⁻⁷ | 1.4*10⁻⁴ |

First, as shown in Table 1, it can be seen that Ag and NiCr have very high fracture toughness, which is one of the mechanical properties, compared to other ceramic materials due to the inherent ductility and stiffness of metal. When a material for a surface type heating element has high fracture toughness, the material itself has high resistance to thermal shock arising when a surface type heating element is used, and thus the lifetime and reliability of the electric range can be significantly improved.

In addition, it can be seen from Table 1 that the NiCr of the embodiment of the present disclosure has a thermal expansion coefficient lower than that of existing Ag. The coefficient of thermal expansion is one of the important factors that determine thermal shock caused by a thermal change arising when the surface type heating element is used. Therefore, when the NiCr alloy and Ag are exposed to the same temperature change, the NiCr alloy has a thermal expansion coefficient lower than that of Ag and thus is subjected to less thermal shock or thermal stress compared with Ag. As a result, the surface type heating element made of the NiCr alloy is subjected to less thermal shock compared with a surface type heating element made of Ag, which is more advantageous in terms of the lifetime and reliability of the electric range.

Meanwhile, Table 1 shows electrical resistivity in addition to mechanical properties. Most of the materials that can be used as a material for a surface type heating element have an electrical resistivity of about 10⁻⁵ to 10⁻² Ωcm, as measured at room temperature, except for Ag. When the electrical resistivity of the surface type heating element is more than 10⁻² Ωcm, it is likely that the pattern of the heating element need not be designed due to excessively high resistivity. In addition, when the electrical resistivity is more than 10⁻² Ωcm, the output of the surface type heating element is excessively low, resulting in a low heating temperature, which is unsuitable for use as a cooking appliance. On the other hand, when the electrical resistivity of the surface type heating element is less than 10⁻⁵ Ωcm, the output is very high due to excessively low resistivity, resulting in an excessively high temperature of heat generated by applying an electric current, which is unsuitable in terms of reliability.

In view of the above criteria, it can be seen that Ag alone is not suitable for the surface type heating element, whereas the NiCr alloy of the embodiment of the present disclosure can be used alone as well as in combination with other components as the surface type heating element.

Meanwhile, in Table 1, the materials for the surface type heating element need to have a small change in electrical resistivity according to temperature.

Generally, the electrical resistivity of the material varies depending on a change in temperature. However, depending on the category of each material type, the behavior of the change in resistivity of the material according to temperature is very different.

For example, in the instance of lanthanum cobalt oxide (LC) or ceramic materials such as MoSi₂ and SiC shown in Table 1, electricity is usually transferred by lattice vibration. The lattices constituting the ceramic material vibrate more widely and rapidly as the temperature increases. Therefore, the resistivity of the ceramic material tends to decrease with increasing temperature.

On the other hand, in the instance of metals such as Ag and NiCr shown in Table 1, electricity is transferred by free electrons. The lattices constituting the metal also vibrate more widely and rapidly as the temperature increases. However, in the instance of the metal, the transfer of electricity is usually performed by free electrons, and the movement of free electrons is restricted by the vibration of the lattice. Therefore, the lattices of the metal vibrate more rapidly and widely as the temperature increases so as to interfere with the movement of free electrons. As a result, electrical resistivity tends to increase with increasing temperature.

The NiCr alloy of the embodiment of the present disclosure has a very small change in electrical resistivity within 5% in the range from room temperature to the maximum operating temperature at which the electric range can be used. When the NiCr alloy is used as the surface type heating element of the electric range, an initial inrush current required at the beginning of the operation of the electric range is lowered such that the risk is eliminated, and it is possible to stably operate the electric range without an additional unit such as a triode for alternating current (TRIAC).

On the other hand, when Ag is used as the surface type heating element of the electric range, the excessively low resistivity and high temperature coefficient of resistance of Ag result in the risk of considerably increasing an initial inrush current at the beginning of the operation of the electric range and the disadvantage of necessarily requiring a separate unit such as a TRIAC.

In the embodiment of the present disclosure, the buffer layer disposed on substrate can have a final thickness of 1 to 10 μm after firing.

When the thickness of the buffer layer is less than 1 μm, the physical thickness of the buffer layer is not sufficient to minimize stress caused by a difference in coefficient of thermal expansion between the substrate and the surface type heating element layer.

When the thickness of the buffer layer is more than 10 μm, it is not effective in minimizing stress caused by a difference in coefficient of thermal expansion between the substrate and the surface type heating element layer and correcting the thickness of the substrate and the thickness of the surface type heating element layer. In particular, in the instance of the surface type heating element layer including a metal material such as NiCr according to the embodiment of the present disclosure, when the thickness of the buffer layer is excessively high in the heterogeneous bonding between the metal which is the surface type heating element layer and the ceramic which is the substrate, adhesive strength between the surface type heating element layer and the substrate and/or the buffer layer thereunder is rather decreased.

In addition, the buffer layer of the embodiment of the present disclosure functions to correct the thickness of the substrate and the thickness of the surface type heating element layer. Therefore, when the thickness of the buffer layer is more than 10 μm, more materials than required in the thickness correction are consumed. On the other hand, when the thickness of the buffer layer is less than 1 μm, it is difficult to realize an effect of correcting the thickness using the buffer layer.

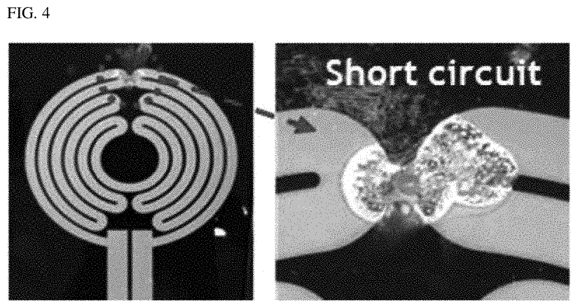

The buffer layer 20 can protect the user from an electric shock occurring due to a back leakage current that can be caused by a decrease in resistivity of the substrate at high temperature. In addition, the buffer layer 20 can prevent a short-circuit current in the surface type heating element layer 30 during high-power operation of the surface type heating element layer 30 due to having relatively high resistivity at high temperature (see FIG. 4) and thus prevent the surface type heating element layer 30 from being destroyed.

To this end, the buffer layer 20 of the present disclosure needs to have an electrical resistivity of 10⁴ Ωcm or more. When the electrical resistivity of the buffer layer 20 is less than 10⁴ Ωcm, it is difficult to prevent a short-circuit current at high temperature or the destruction of the surface type heating element layer. Meanwhile, the electrical resistivity of the buffer layer 20 can be higher than 10⁴ Ωcm, but it is difficult to be higher than 10⁵ Ωcm due to compatibility with the surface type heating element layer 30 to be described below and material factors.

In addition, the buffer layer 20 of the embodiment of the present disclosure does not need to react unnecessarily with the substrate 10 and the surface type heating element layer 30 in contact therewith at room temperature and high temperature while ensuring adhesion to the substrate 10 and/or the surface type heating element layer 30 and, furthermore, needs to have compatibility with printing and subsequent processes.

To this end, the buffer layer 20 of the embodiment of the present disclosure can include an inorganic binder. Particularly, in the embodiment of the present disclosure, glass frit can be included as the inorganic binder to decrease a firing temperature.

More specifically, the buffer layer of the embodiment of the present disclosure includes borosilicate glass as the glass frit. This is because the borosilicate greatly helps to suppress cracking and peeling of the surface type heating element layer 30 due to a difference in coefficient of thermal expansion from the substrate 10 by having a thermal expansion coefficient similar to that of the surface type heating element layer 30 or a thermal expansion coefficient of about 50*10⁻⁷ m/° C. which is almost the mean of the thermal expansion coefficients of the substrate 10 and the surface type heating element layer 30 to be described below.

In addition, the reason why the upper limit of the thermal expansion coefficient of the buffer layer of the embodiment of the present disclosure is similar to that of the surface type heating element layer is that the buffer layer and the substrate have a ceramic-ceramic layered structure, whereas the buffer layer and the surface type heating element layer have a ceramic-metal stacked structure. In more detail, first, in the ceramic-ceramic layered structure, the adhesive strength at the interface is high, so high resistance to thermal shock or thermal stress is exhibited at the interface even when there is a difference in thermal expansion coefficient. On the other hand, in the ceramic-metal layered structure, the adhesive strength at the interface is low, and thus the interface is more vulnerable to thermal shock or thermal stress.

The glass frit of the embodiment of the present disclosure includes SiO₂ as a network former that forms a network structure which is a basic structure of glass.

Generally, it is known that SiO₂, B₂O₃, P₂O₅, and the like are typically used as components that can be used as a network former for glass. However, P₂O₅ and the like do not effectively suppress the reaction between the buffer layer including the glass frit of the present disclosure and the substrate and/or the surface type heating element layer. Therefore, in the embodiment of the present disclosure, SiO₂ is included as a first network former to improve the stability and reliability of the buffer layer.

In this instance, SiO₂ can be included at 60 to 70% by weight (hereinafter, also referred to as “wt %” or “%”). When the content of SiO₂ is less than 60%, a coefficient of thermal expansion is excessively increased due to an unstable network structure, and furthermore, the proportion is outside of the composition ratio where glass formation is possible, making it difficult to form glass. On the other hand, when the content of SiO₂ is more than 70%, a coefficient of thermal expansion is excessively decreased due to a highly stable network structure and the high-temperature stability of the network structure, and furthermore, a glass formation temperature is excessively increased.

Meanwhile, the buffer layer of the embodiment of the present disclosure includes B₂O₃ as a second network former. In this instance, B₂O₃ can be included at 15 to 25% by weight (hereinafter, also referred to as “wt %” or “%”). When the content of B₂O₃ is less than 15%, a coefficient of thermal expansion is excessively increased due to an unstable network structure, and furthermore, the proportion is outside of the composition ratio where glass formation is possible, making it difficult to form glass. On the other hand, the content of B₂O₃ is more than 25%, a coefficient of thermal expansion is excessively decreased due to a highly stable network structure and the high-temperature stability of the network structure, and furthermore, a glass formation temperature is excessively increased.

Meanwhile, most glass includes a network modifier that destroys the network structure formed by the network former as an essential component. Such a network modifier is an ionic-bonding oxide that does not form glass alone but cleaves the skeletal structure of the glass including a chemical bond of covalent nature when mixed with the network former at a predetermined ratio. As a typical network modifier added to glass, alkali metal oxides or alkaline earth metal oxides are commonly used.

According to the buffer layer of the embodiment of the present disclosure, typical alkali metal oxides such as Na₂O and/or K₂O as a network modifier along with BaO are included in the glass frit.

The reason why BaO is included in the buffer layer of the embodiment of the present disclosure is that BaO can further increase the coefficient of thermal expansion of glass when compared to other alkaline earth metal oxides. Furthermore, BaO in the present disclosure is highly effective in lowering the characteristic temperatures of glass, such as a melting point and a softening point. The characteristics of BaO which affect the characteristic temperatures of glass ultimately greatly affect an improvement in adhesiveness of the glass frit of the present disclosure and processability for co-firing with the surface type heating element layer to be described.

In the glass frit of the embodiment of the present disclosure, the alkali oxide can be included at 10% or less, and the BaO can be included at 1 to 5%.

When the content of BaO is less than 1%, the glass frit has a stable network structure even at high temperature due to having an excessively stable network structure, and thus it is difficult to form glass. Also, even when glass is formed, the coefficient of thermal expansion of the buffer layer is excessively decreased.

On the other hand, when the content of BaO is more than 5%, and the content of the alkali oxide also is more than 10%, the proportion is outside of the composition ratio where glass formation is possible, and, even when glass is formed, the coefficient of thermal expansion of the buffer layer is excessively increased.

Next, the glass frit in the buffer layer of the embodiment of the present disclosure includes Al₂O₃ as an intermediate.

Glass typically contains oxides that stabilize a network structure, and these oxides are referred to as an intermediate. Along with BaO, Al₂O₃ generally decreases the viscosity and characteristic temperatures, such as a melting point and a softening point, of glass and, as a result, allows glass to be easily processed even at low temperature.

The glass frit of the embodiment of the present disclosure can include Al₂O₃ at 1 to 10 wt %.

When the content of Al₂O₃ is less than 1%, the proportion is outside of the composition ratio where glass formation is possible, making it difficult to form glass. Also, even when glass is formed, the coefficient of thermal expansion of the buffer layer is excessively increased due to an unstable network structure.

On the other hand, when the content of Al₂O₃ is more than 10%, the proportion is outside of the composition ratio where glass formation is possible, and, even when glass is formed, the coefficient of thermal expansion of the buffer layer is decreased due to a stable network structure even at high temperature. Also, a glass formation temperature is excessively increased, and thus manufacturing costs are also increased.

The buffer layer of the embodiment of the present disclosure is formed by preparing a paste including the glass frit and applying the paste onto the substrate 10.

The paste of the present disclosure means a mixture of a vehicle containing essential components such as a solvent, an organic binder, and the like and optional components such as various types of organic additives and particles (powder) of the glass frit that is responsible for a main function on the substrate after firing (or sintering).

More specifically, the paste of the buffer layer of the embodiment of the present disclosure consists of an organic binder at 1 to 10 wt %, a solvent at 20 to 40 wt %, an additive at 5 wt % or less, and borosilicate glass frit having the component and composition ranges described above as the remainder.

The organic binder of the embodiment of the present disclosure can include a thermoplastic resin and/or a thermosetting resin. As the thermoplastic binder, acryl-based, ethyl cellulose-based, polyester-based, polysulfone-based, phenoxy-based, and polyamide-based binders can be used. As the thermosetting binder, amino, epoxy, and phenol binders can be used. In this instance, the organic binder can be used alone or in combination of two or more.

When the content of the organic binder is less than 1 wt %, the mechanical stability of a coating film is decreased in coating with the buffer layer, and thus it is difficult to stably maintain the coating film. On the other hand, when the content of the organic binder is more than 10 wt %, the mechanical stability of the coating film is decreased due to high fluidity, and the thickness of the final the buffer layer 20 is excessively decreased.

The solvent of the embodiment of the present disclosure can have high volatility sufficient to ensure complete dissolution of the organic substance in the paste, particularly, the polymer and to be evaporated even when a relatively low level of heat is applied under atmospheric pressure. In addition, the solvent should boil or volatilize well at a temperature below the decomposition temperature or boiling point of any other additives contained in the organic medium. For example, a solvent having a boiling point of less than 150° C., as measured at atmospheric pressure, is most commonly used.

The solvent of the present disclosure is selected according to the type of organic binder. As the solvent, aromatic hydrocarbons, ethers, ketones, lactones, ether alcohols, esters, diesters, or the like can be generally used. As a non-limiting example, such a solvent includes butyl carbitol, butyl carbitol acetate, acetone, xylene, methanol, ethanol, isopropanol, methyl ethyl ketone, ethyl acetate, 1,1,1-trichloroethane, tetrachloroethylene, amyl acetate, 2,2,4-triethyl pentanediol-1,3-monoisobutyrate, toluene, methylene chloride, and fluorocarbon. In this instance, the solvent can be used alone or in combination of two or more. Particularly, a solvent mixed with other solvents can be preferred for complete dissolution of the polymer binder.

When the content of the solvent is less than 20 wt %, the paste does not have sufficient fluidity, and thus it is difficult to form the buffer layer 20 by a coating method such as screen printing. On the other hand, when the content of the solvent is more than 40 wt %, the paste has high fluidity, and thus the mechanical stability of the coating film is decreased.

The paste of the embodiment of the present disclosure can include, as an additive, for example, a plasticizer, a releasing agent, a dispersing agent, a remover, an antifoaming agent, a stabilizer, a wetting agent, and the like. As a non-limiting example, a phosphoric acid-based dispersing agent and the like can be added to uniformly disperse glass frit powder.

The paste including the glass frit and the vehicle is prepared by weighing components constituting the paste in a desired composition ratio and uniformly mixing the weighed components using a three-roll mill and a paste mixer at 10 to 30° C. for 2 to 6 hours.

Next, the paste is applied onto the substrate. As a non-limiting example of the coating method, there is a screen printing method. As another example of the coating method, the buffer layer 20 can be formed by casting the paste on an additional flexible substrate, removing a volatile solvent while heating the cast layer to form a green tape, and laminating the tape on the substrate using a roller.

After the coating step, drying the applied paste for the buffer layer 20 at a predetermined temperature is performed. The drying step is typically performed at 200° C. or less which is a relatively low temperature. In the drying step, the solvent is mainly evaporated.

Next, a binder burnout (BBO) step of burning and eliminating the organic binder which is an active component in the dried buffer layer 20 can be further included. For the BBO, a section in which a constant temperature is maintained in the firing step can be provided additionally. Alternatively, a speed control method of slowing a heating rate only in the temperature range where the BBO occurs in the firing step can be adopted.

After the drying and BBO steps, the buffer layer 20 can be formed by a firing process such as a sintering process. The buffer layer of the embodiment of the present disclosure can be formed by various sintering methods. As a non-limiting example, the buffer layer of the embodiment of the present disclosure can be formed by thermal sintering.

Meanwhile, various characteristic temperatures of the glass frit of the embodiment of the present disclosure are determined by the component and composition ranges as described above. In addition, the characteristic temperatures greatly affect sintering conditions.

First, the glass frit of the buffer layer of the embodiment of the present disclosure can have a glass transition temperature of 450 to 550° C. When formed and then heated, glass has no exact melting point unlike a crystalline solid and has a transition point that shows only a gradient change in volume increase, and the temperature at this time is referred to as a glass transition temperature.

In addition, the glass frit of the buffer layer of the embodiment of the present disclosure can have a softening point of 600 to 700° C. Particularly, a softening point is very important in the formation method of the buffer layer of the embodiment of the present disclosure because the lower limit of the firing (or sintering) temperature at which the buffer layer of the embodiment of the present disclosure is formed needs to be higher than at least a softening point.

The conditions of sintering of the buffer layer of the embodiment of the present disclosure need to be determined in consideration of the thermal characteristic temperatures of the glass frit of the present disclosure. Specifically, the sintering conditions under which the buffer layer of the embodiment of the present disclosure is formed can preferably include a sintering temperature of 750 to 950° C. and a sintering time of 0.1 to 2 hours.

When the sintering temperature is lower than 750° C. or the sintering time is shorter than 0.1 hours, the viscosity of the glass frit is increased due to low sintering temperature and a short sintering time during thermal sintering, and thus fluidity is not sufficiently ensured. Accordingly, bonding strength between the buffer layer and the substrate is decreased, and the surface roughness of the buffer layer is excessively increased. On the other hand, although there is no upper limit of a sintering temperature, when the sintering temperature is higher than 950° C., the substrate can be thermally deformed or destroyed due to an excessively high sintering temperature. In addition, when the sintering time is longer than 2 hours, the substrate is highly likely to be thermally deformed due to excessively high thermal energy applied to the substrate.

The electric range of the embodiment of the present disclosure includes the surface type heating element layer 30 disposed on the buffer layer 20. In this instance, the heating element of the surface type heating element layer 30 is arranged in a predetermined shape on the substrate 10 or the buffer layer 20 when viewed from above.

As an example referring to FIG. 1, the surface type heating element can be formed on the surface of the buffer layer 20 by extending along a circumference in a zigzag manner while varying a direction based on a semicircle. In this instance, the surface type heating element can be formed continuously from a first terminal unit 31 to a second terminal unit 32 in a predetermined shape.

In this instance, the surface type heating element layer 30 of the embodiment of the present disclosure includes a Ni—Cr alloy. In the Ni—Cr alloy of the present disclosure, a base material is Ni and Cr is provided as a solute. In this instance, a Cr content in Ni—Cr alloy can range from 5 to 40% by weight (hereinafter, also referred to as “wt %” or “%”). When the Cr content in Ni—Cr alloy is less than 5 wt %, corrosion resistance is decreased, and thus the surface type heating element layer can be vulnerable to high temperature or chemicals. On the other hand, when the Cr content is more than 40 wt %, processability which is a characteristic of the face-centered cubic lattice of the base Ni is degraded, and furthermore, heat resistance is decreased. As a result, when the electric range is used at high temperature for a long time, the reliability of the electric range can be decreased.

Specifically, the surface type heating element layer 30 of the embodiment of the present disclosure includes a NiCr alloy powder. The NiCr alloy powder of the embodiment of the present disclosure can have an average particle size (D50) of 10 nm to 10 μm. When the NiCr alloy powder has an average particle size (D50) of less than 10 nm, the surface area of the powder is excessively increased, and the activity of the powder is increased. As a result, the NiCr alloy powder in the form of a paste is not uniformly dispersed. On the other hand, when the NiCr alloy powder has an average particle size (D50) of more than 10 μm, due to an excessively large particle size of the NiCr alloy powder, there is less necking between powder particles, or the powder is not uniformly dispersed. As a result, resistivity is excessively increased, and the adhesion between the surface type heating element layer 30 and the buffer layer 20 thereunder is decreased.

The NiCr alloy powder of the present disclosure is included together with other inorganic substances and the vehicle in the paste for forming a surface type heating element layer. In this instance, the composition of the surface type heating element paste is determined according to the application method.

More specifically, when the surface type heating element layer 30 is co-fired with the buffer layer 20 thereunder, the surface type heating element paste can a include glass frit at 3 wt % or less (excluding 0 wt %), an organic binder at 10 to 30 wt %, a solvent at 5 to 30 wt %, an additive at 1 to 10 wt %, and a NiCr alloy powder as the remainder.

In this instance, the glass frit in the surface type heating element paste can be the same as the glass frit in the buffer layer 20. When the buffer layer 20 and the surface type heating element layer 30 have the same glass frit, the firing conditions of the buffer layer and the surface type heating element layer are the same, and furthermore, the bonding strength between the buffer layer and the surface type heating element layer can be increased due to excellent material compatibility. In addition, when the co-firing of the buffer layer and the surface type heating element layer is possible, the formation of the buffer layer and the surface type heating element layer is completed by only one thermal sintering, and thus the thermal damage to the substrate, energy required for the process, and the process time are reduced.

On the other hand, when the surface type heating element layer 30 of the present disclosure is formed by photonic sintering with intense pulsed white light, the surface type heating element paste can include an organic binder at 10 to 30 wt %, a solvent at 5 to 30 wt %, an additive at 1 to 10 wt %, and a NiCr alloy powder as the remainder. In other words, the surface type heating element paste which is applied in photonic sintering does not include a glass frit.

When the surface type heating element layer of the present disclosure is formed by the photonic sintering, since the substrate 10 and the buffer layer 20 are not exposed to high temperature for a long time, the possibility that the substrate and the buffer layer are contaminated from the outside is significantly reduced. In addition, since the photonic sintering process does not require a long-term high temperature heating process, the thermal damage to the substrate, energy required for the process, and the process time are reduced.

The surface type heating element layer 30 of the embodiment of the present disclosure is first applied in the form of a paste onto the buffer layer 20, and then the applied paste is dried. The drying step is typically performed at a relatively low temperature of 200° C. or less, and, in the drying step, the solvent is mainly evaporated. Afterward, the dried surface type heating element layer 30 is co-fired with the buffer layer under the above-described firing conditions of the buffer layer or photonically sintered with intense pulsed white light under conditions to be described below.

As a non-limiting example, the intense pulsed white light in the present disclosure can be intense pulsed white light emitted from a xenon lamp. When the dried paste for the surface type heating element is irradiated with intense pulsed white light, the paste is sintered by radiant energy of intense pulsed white light, and thereby the surface type heating element can be formed.

More specifically, when the dried paste is irradiated with intense pulsed white light, first, the organic substances, especially, the binder, present in the paste are burned out (BBO). In the preceding drying step, the solvent among organic vehicle components constituting the paste is mainly volatilized. Therefore, after the drying step, the binder among the organic vehicle components serves to bind a solid NiCr alloy powder components in the dried paste, and thus the mechanical strength of the dried paste can be maintained. Afterwards, the binder is eliminated by radiant energy of radiated intense pulsed white light at an initial stage of photonic sintering, and this phenomenon or step is referred to as BBO.

After the BBO, most of the organic vehicle components are no longer present in the paste. Accordingly, the remaining NiCr alloy powder components are sintered by irradiation with intense pulsed white light, and thereby the final surface type heating element layer 30 is formed. In this instance, the NiCr alloy powder which is a powder component is sintered by the intense pulsed white light to form necks between individual powder particles, and thus the macroscopic resistivity of the surface type heating element layer 30 can be reduced.

A total light irradiation intensity in the photonic sintering process of the present disclosure can range from 40 to 70 J/cm². When the total light irradiation intensity is less than 40 J/cm², it is difficult to form necks between NiCr powder particles and thus to form coupling between NiCr powder particles, resulting in excessively high resistivity of the surface type heating element layer 30. In addition, after the photonic sintering, the surface type heating element layer 30 does not have sufficient adhesive strength with respect to the substrate and thus is detached from the substrate. On the other hand, when the total light irradiation intensity is more than 70 J/cm², NiCr particles are oxidized due to an excessively high light irradiation intensity, and thus the oxidation film formed on the surface of NiCr particles causes the resistivity of the surface type heating element layer 30 to be excessively increased. In addition, the substrate was shrunk due to excessive light irradiation intensity and thus cracked or broken in severe instances.

Meanwhile, the photonic sintering process of the present disclosure can be operated with 1 to 30 pulses during the entire photonic sintering process. A pulse duration (or pulse on time) can range from 1 to 40 ms, and a pulse interval (or pulse off time) can range from 1 to 500 ms.

The surface type heating element layer 30 which has been finally sintered through the photonic sintering process of the present disclosure can have a thickness of 1 to 100 μm. When the thickness of the surface type heating element layer 30 is less than 1 μm, it is difficult to ensure a dimensionally stable surface type heating element layer, and the thermal stability and mechanical stability of the surface type heating element layer 30 are decreased due to local heating. On the other hand, when the thickness of the surface type heating element layer 30 is more than 100 μm, there are problems such as cracks are highly likely to occur due to a difference in material or thermal expansion coefficient from the substrate and the buffer layer, and a process time increases.

Meanwhile, the surface type heating element layer 30 using the NiCr alloy powder of the present disclosure can have an electrical resistivity of 10⁻⁴ to 10⁻² Ωcm. When the electrical resistivity of the surface type heating element is more than 10⁻² Ωcm, the output of the surface type heating element is decreased due to excessively high resistivity. Therefore, the thickness of the surface type heating element should be increased to lower the resistivity of the surface type heating element, but an increase in the thickness of the surface type heating element also affects the coefficient of thermal expansion of the surface type heating element, and thus the stability of the surface type heating element is significantly decreased. On the other hand, when the electrical resistivity of the surface type heating element is less than 10⁻⁴ Ωcm, a current exceeding an allowable current flows due to excessively low resistivity, and thus the output of the surface type heating element is excessively increased. Therefore, in order to lower the resistivity of the surface type heating element, terminal resistance should be increased by reducing the thickness, but the excessively thin thickness of the surface type heating element also causes the heat resistance of the surface type heating element to be decreased.

### EXAMPLES

In Examples of the present disclosure, buffer layers 20 were formed of glass frit with the compositions shown in the following Table 2.

TABLE 2
Component and composition ranges of glass frit.

| | Example 1 | Comparative Example 1 |
|---|---|---|
| Components | (wt %) | (wt %) |
| SiO₂ | 65 | 74 |
| B₂O₃ | 16 | 15 |
| Al₂O₃ | 6 | 4 |
| BaO | 5 | 5 |
| Alkali | 8 | 2 |

Each of glass frits with the compositions of Example 1 and Comparative Example 1 was batched and then mixed with a solvent and a binder in a planetary mixer at 10 to 30° C. for 2 to 6 hours, thereby preparing a paste having a viscosity of 100 Kcp.

The paste was applied with a thickness of 10 to 12 μm on a glass substrate using a screen printer, dried at 150° C. for 10 minutes, subjected to a BBO process at 450° C. for 30 minutes, and then fired at 800 to 900° C. for 30 minutes, thereby finally forming a buffer layer 20 of the present disclosure. In this instance, the thermal expansion coefficients of the buffer layer with the composition of Example 1 and the buffer layer with the composition of Comparative Example 1 were measured to be 60*10⁻⁷ m/° C. and 30*10⁻⁷ m/° C., respectively.

Next, a paste including NiCr alloy powder was applied on the buffer layer with the composition of Example 1 and the buffer layer with the composition of Comparative Example 1, thereby forming surface type heating element layers.

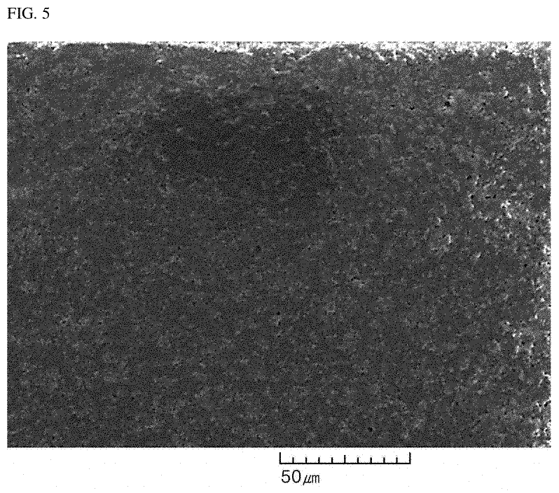

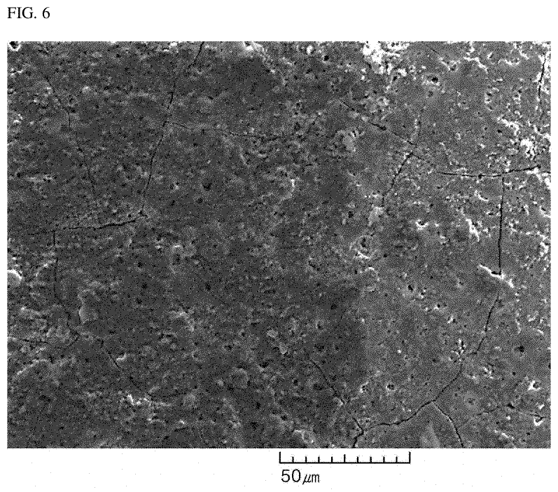

FIGS. 5 and 6 are scanning electron microscope (SEM) images of surface type heating element layers formed on the buffer layer formed of the glass frit with the composition of Example 1 and the buffer layer formed of the glass frit with the composition of Comparative Example 1, respectively.

The surface of the surface type heating element layer of FIG. 5 has a microstructure without any defects or cracks. It is speculated that the excellent surface morphology of the surface type heating element layer of FIG. 5 is because the buffer layer, which is disposed under the surface type heating element layer and has a thermal expansion coefficient which is a mean of the thermal expansion coefficient of the surface type heating element layer and the thermal expansion coefficient of the glass substrate, reduces thermal stress applied to the surface type heating element layer.

On the other hand, the surface of the surface type heating element layer of FIG. 6 has many cracks. In the instance of the surface type heating element layer of FIG. 6, the buffer layer is also disposed under the surface type heating element layer, but the buffer layer in FIG. 6 includes the glass frit with the composition of Comparative Example 1, for example, with a large amount of SiO₂ and a small amount of an alkali component. The glass frit of Comparative Example 1 has an excessively stable network structure due to the compositional characteristic and, as a result, has a thermal expansion coefficient lower than the glass frit of Example 1. Therefore, the buffer layer having a relatively low thermal expansion coefficient does not effectively reduce thermal stress applied to the surface type heating element layer having a relatively high thermal expansion coefficient, and accordingly, numerous cracks are generated in the surface of the surface type heating element layer of FIG. 6.

According to the present disclosure, a surface type heating element designed using a metal component having a high melting point is provided, and thus the operating temperature of an electric range to which the surface type heating element is applied can further increase to 450° C. or more compared with an existing operating temperature thereof, and furthermore, the reliability of a cooktop product such as an electric range can be improved by preventing the elution of the metal component even at the high operating temperature.

In addition, the surface type heating element according to the present disclosure is designed to have both high fracture toughness inherent in the metal and a coefficient of thermal expansion lower than other metals, and thus resistance to thermal shock, which is caused by a difference in temperature which is generated during use of a cooktop and a difference in coefficient of thermal expansion between the surface type heating element layer and the substrate or the buffer layer thereunder, can be ensured, and furthermore, thermal shock itself can be reduced. As a result, the present disclosure can provide an effect of significantly improving the lifetime and reliability of a cooktop which is a practical product.

Furthermore, since the surface type heating element of the present disclosure includes a buffer layer which is disposed between a substrate and a surface type heating element layer and has controlled component and composition ranges so that the buffer layer has a coefficient of thermal expansion between the thermal expansion coefficient of the surface type heating element layer and the thermal expansion coefficient of the substrate or similar to the thermal expansion coefficient of the surface type heating element, thermal shock or thermal stress applied to the surface type heating element layer due to a difference in coefficient of thermal expansion between the substrate and the surface type heating element can be reduced. In addition, the high electrical resistivity of the buffer layer at high temperature can protect the user from a leakage current that can be generated in the surface type heating element.

In addition, since the surface type heating element of the present disclosure includes a metal having a low temperature coefficient of resistance which indicates a change in resistance value according to temperature, an initial inrush current required at the beginning of the operation of a cooktop is lowered, and thus a user's safety against an overcurrent can be ensured. Furthermore, a control unit such as a triode for alternating current (TRIAC) is not required.

Additionally, the metal material of the surface type heating element of the present disclosure can be used alone as the surface type heating element without mixing with other metals or ceramic powder because the material itself has a resistance value higher than that of other metals. Therefore, the surface type heating element of the present disclosure can exhibit improved reactivity with other materials and improved stability and storability of a paste and also achieve a cost reduction effect in terms of material costs.

A method of manufacturing a surface type heating element of the present disclosure can provide an effect of preventing thermal oxidation or deformation of the material by reducing an exposure time of the material to a high process temperature by shortening a process time even though a buffer layer is included.

In particular, the method of manufacturing a surface type heating element of the present disclosure can provide an effect of suppressing oxidation or thermal deformation of the material including the substrate material by lowering a process temperature by designing the component and composition ranges of the material in the formation of a buffer layer and/or a surface type heating element layer.

Meanwhile, the method of manufacturing a surface type heating element of the present disclosure can reduce a process time and energy by excluding a high-temperature process if possible, and, furthermore, provide a surface type heating element with higher quality by fundamentally excluding contamination of materials, which can occur from a thermal insulation system in long-term high temperature thermal treatment. The method of manufacturing a surface type heating element of the present disclosure, which is capable of excluding a high-temperature process, does not require a thermal insulation system required for high-temperature thermal treatment and an additional facility for producing a reducing process atmosphere, so that the process facility can be simplified.

In addition, the method of manufacturing a surface type heating element of the present disclosure can reduce the tact time of the entire process by shortening the unit process time (lead time) and thus provide a productivity improvement effect.

Although the present disclosure has been described above with reference to the illustrated drawings, it is obvious that the present disclosure is not limited to the embodiments and drawings disclosed herein, and various modifications can be made by those skilled in the art within the spirit and scope of the present disclosure. In addition, even when the effect of the configuration of the present disclosure is not explicitly described while the above-described embodiments of the present disclosure are described, it is obvious that the effect predictable by the corresponding configuration should also be recognized.

What is claimed is:

1. A surface type heating element to generate heat using electricity, the surface type heating element comprising:
a substrate;
a buffer layer disposed on the substrate, the buffer layer having a thermal expansion coefficient of about 50*10⁻⁷ to about 100*10⁻⁷ m/° C.; and
a surface type heating element layer including a NiCr alloy, and disposed on the buffer layer.

2. The surface type heating element of claim 1, wherein the substrate is formed of any one of glass, a glass ceramic, Al₂O₃, AlN, polyimide, polyether ether ketone (PEEK), and a ceramic.

3. The surface type heating element of claim 1, wherein the buffer layer has a thickness of about 1 to about 10 μm.

4. The surface type heating element of claim 1, wherein the buffer layer has an electrical resistivity of about 10⁴ to about 10⁵ Ωcm.

5. The surface type heating element of claim 1, wherein the buffer layer includes a glass frit, and the glass frit includes SiO₂ at about 60 to about 70 wt %, B₂O₃ at about 15 to about 25 wt %, Al₂O₃ at about 1 to about 10 wt %, an alkali oxide at about 10 wt % or less and greater than 0%, and BaO at about 1 to about 5 wt %, of the glass frit.

6. The surface type heating element of claim 5, wherein the glass frit has a glass transition temperature of about 450 to about 550° C.

7. The surface type heating element of claim 5, wherein the glass frit has a softening point of about 600 to about 700° C.

8. The surface type heating element of claim 1, wherein a Ni content of the NiCr alloy ranges from about 60 to about 95 wt %, of the surface type heating element layer.

9. The surface type heating element of claim 1, wherein the surface type heating element layer has an electrical resistivity of about 10⁻⁴ to about 10⁻² Ωcm.

10. A method of manufacturing a surface type heating element to generate heat using electricity, the method comprising:
providing a substrate;
forming a buffer layer disposed on the substrate, the buffer layer having a thermal expansion coefficient of about 50*10⁻⁷ to about 100*10⁻⁷ m/° C.;
applying a surface type heating element layer including a NiCr alloy onto the buffer layer;
drying the applied surface type heating element layer; and
sintering the dried surface type heating element layer.

11. The method of claim 10, wherein the forming of the buffer layer includes:
applying the buffer layer;
drying the applied buffer layer; and
sintering the dried buffer layer, and
wherein the dried buffer layer and the dried surface type heating element layer are co-sintered.

12. The method of claim 11, wherein the co-sintering is performed at a sintering temperature of about 750 to about 950° C. for a sintering time of about 0.1 to about 2 hours.

13. The method of claim 10, wherein the forming of the buffer layer includes:
applying the buffer layer;
drying the applied buffer layer; and
sintering the dried buffer layer, and
wherein the sintering of the dried surface type heating element layer is performed by photonic sintering.

14. The method of claim 10, wherein the substrate is formed of any one of glass, a glass ceramic, Al₂O₃, AlN, polyimide, polyether ether ketone (PEEK), and a ceramic.

15. The method of claim 10, wherein the buffer layer has a thickness of about 1 to about 10 μm.

16. The method of claim 10, wherein the buffer layer has an electrical resistivity of about 10⁴ to about 10⁵ Ωcm.

17. The method of claim 10, wherein the buffer layer includes a glass frit, and the glass frit includes SiO₂ at about 60 to about 70 wt %, B₂O₃ at about 15 to about 25 wt %, Al₂O₃ at about 1 to about 10 wt %, an alkali oxide at about 10 wt % or less and greater than 0%, and BaO at about 1 to about 5 wt %, of the glass frit.

18. The method of claim 17, wherein the glass frit has a glass transition temperature of about 450 to about 550° C. and a softening point of about 600 to about 700° C.

19. The method of claim 10, wherein a Ni content of the NiCr alloy ranges from about 60 to about 95 wt %.

20. The method of claim 10, wherein the surface type heating element layer has an electrical resistivity of about 10⁻⁴ to about 10⁻² Ωcm.
